(19) United States
(12) Patent Application Publication
(10) Pub. No.: US 2018/0161929 A1
(43) Pub. Date: Jun. 14, 2018

(54) BOX-TYPE LASER PROCESSING MACHINE CAPABLE OF VACUUM DEDUSTING

(71) Applicant: Great Computer Corp., New Taipei City (TW)

(72) Inventor: Chih-Lin CHEN, New Taipei City (TW)

(21) Appl. No.: 15/378,624

(22) Filed: Dec. 14, 2016

(51) Int. Cl. B23K 26/142; B23K 26/16

(52) U.S. Cl. CPC B23K 26/142; B23K 26/16

(57) ABSTRACT

A box-type laser processing machine capable of vacuum dedusting includes a chassis; a laser processing area is provided inside the chassis for processing work of a laser output apparatus, and the box-type laser processing machine capable of vacuum dedusting is characterized in that: a plurality of air inlet holes is provided above the laser processing area in the periphery of the chassis, and an air exhaust hole is provided opposite to the laser processing area on the chassis; in this way, when air extraction is performed in the laser processing area inside the chassis by using an air extraction device, air outside the chassis may be guided into the chassis via the plurality of air inlet holes to extract dust generated by processing work out of the chassis via the air exhaust hole.

### BACKGROUND

### Technical Field

The present invention relates to a box-type laser processing machine capable of vacuum dedusting, where the laser processing machine has a simple structure, and can effectively guide air flows to put inner deflagrated dust and cross-ventilation under control.

### Related Art

Currently, in the laser processing industry, a laser cutting and engraving processing technology is a trendy processing technology that is developing rapidly and widely used, and has advantages such as wide applicability, high processing precision, causing no damages on processed workpieces, easy control, high reliability, high processing efficiency, and good engraving quality. A basic principle of a general laser processing machine is that light beams output by laser from a laser head on a pen vehicle are guided and focused to a surface of an engraved object; after the material absorbs the focused light beams, the temperature of the material suddenly rises and the material is gasified, and as a result, the surface of the object is recessed, or, the surface of the processed object is heated and melted by means of the focused high-energy light beams, and at the same, the material is blown down and melted by using high-pressure gases, so that the objective of engraving or cutting is achieved.

However, removing heat and dust generated during laser processing has been always the problem concerned by the industry and users. In particular, as regards a box-type laser processing machine, dust protection inside the machine body of the box-type laser processing machine is generally performed in an isolation-type protection barrier manner. Even though air inside the machine body is extracted by using an air extraction device, upon pressure changes, the isolation-type protection effect is reduced due to cross-ventilation; as a result, most of the dust still remains in the periphery inside in the chassis.

### SUMMARY

The present invention relates to a box-type laser processing machine capable of vacuum dedusting, where the laser processing machine has a simple structure, and can effectively guide air flows to put inner deflagrated dust and cross-ventilation under control.

To achieve the foregoing objective, the present invention provides a box-type laser processing machine capable of vacuum dedusting, which includes a chassis; a laser processing area is provided inside the chassis for processing work of a laser output apparatus, and the box-type laser processing machine capable of vacuum dedusting is characterized in that: a plurality of air inlet holes is provided above the laser processing area in the periphery of the chassis, and an air exhaust hole is provided opposite to the laser processing area on the chassis; in this way, when air extraction is performed in the laser processing area inside the chassis by using an air extraction device, air outside the chassis may be guided into the chassis via the plurality of air inlet holes to extract dust generated by processing work out of the chassis via the air exhaust hole.

In implementation, each of the plurality of air inlet holes has an air window that can be closed or opened, and at least one dust detection apparatus is further provided inside the chassis; further, a control apparatus is provided in the chassis, and is respectively connected to the foregoing dust detection apparatus and air windows; in this way, when the dust detection apparatus detects a dust distribution condition in the laser processing area and reports the condition to the control apparatus, the control apparatus can control air windows at suitable locations to be opened or closed.

To further understand the present invention, preferred embodiments are listed below, and specific content and effects thereof of the present invention are described in detail below with reference to the accompanying drawings and numbers of the accompanying drawings.

### BRIEF DESCRIPTION OF THE DRAWINGS

FIG. 1 is a stereoscopic external view of a box-type laser processing machine capable of vacuum dedusting of an embodiment of the present invention.

FIG. 2 is a schematic external view of a part inside a chassis of an embodiment of the present invention.

FIG. 3 is a schematic diagram of a use state during air extraction of an embodiment of the present invention.

FIG. 4 is a schematic diagram of an architecture during air extraction of an embodiment of the present invention.

FIG. 5 is a schematic diagram of an architecture when a control apparatus is provided of an embodiment of the present invention.

### DETAILED DESCRIPTION

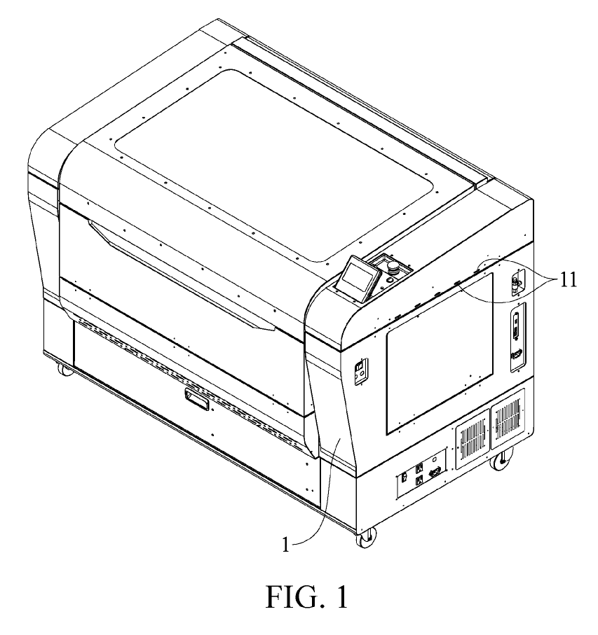

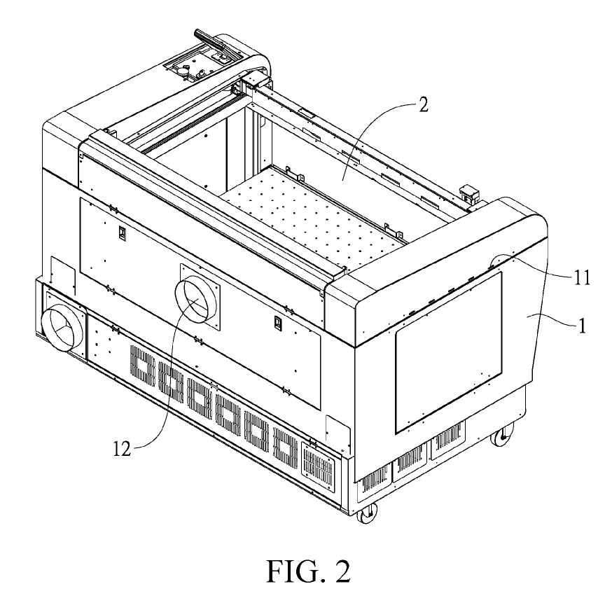

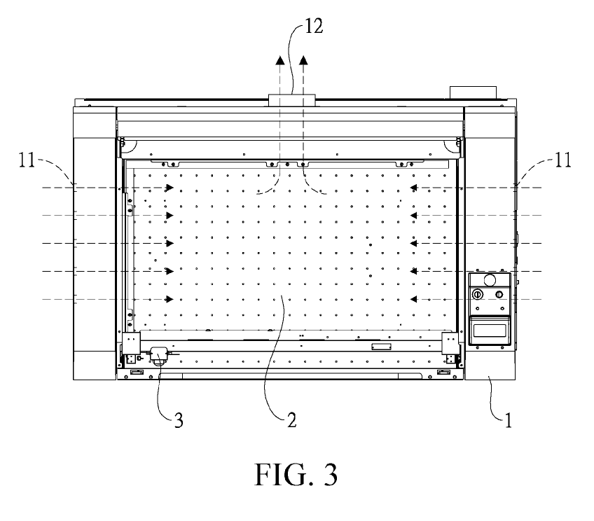

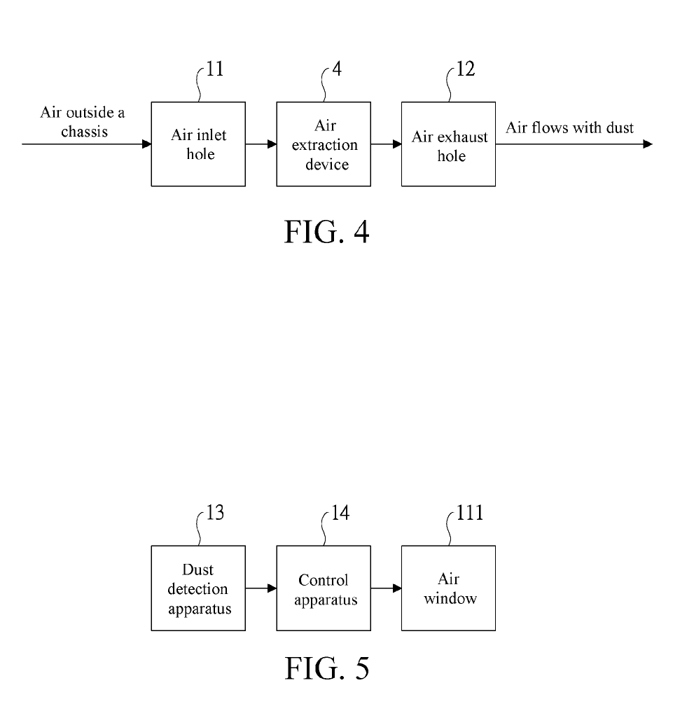

Referring to FIGS. 1 to 4, content of FIGS. 1 to 4 is an embodiment of a box-type laser processing machine capable of vacuum dedusting of the present invention, which includes a chassis 1, and a laser processing area 2 is provided inside the chassis 1 for processing work of a laser output apparatus 3.

A plurality of air inlet holes 11 is provided above the laser processing area 2 in the periphery of the chassis 1, and an air exhaust hole 12 is provided opposite to the laser processing area 2 on the chassis 1. In this way, when air extraction is performed in the laser processing area 2 inside the chassis 1 by using an air extraction device 7, air outside the chassis 1 may be guided into the chassis 1 via the plurality of air inlet holes 11 to extract dust generated by processing work out of the chassis 1 via the air exhaust hole 12.

Therefore, when laser processing work is performed in the laser processing area 2, because the air extraction device 4 performs air extraction on the laser processing area 2 inside the chassis 1 to exhaust air inside the chassis 1 outwards, so that a pressure difference is formed between air pressures inside and outside the chassis 1. Under the effect of the pressure difference, air outside the chassis 1 may be guided into the chassis 1 via the plurality of air inlet holes 11 to form directional air flows to guide air inside the chassis 1, so that air flows with dust can be effectively extracted out of the chassis 1 by the air extraction device 4.

In addition, each of the plurality of air inlet holes 11 has an air window 111 that can be closed or opened, and at least one dust detection apparatus 13 is further provided inside the chassis 1. Furthermore, a control apparatus 14 is provided in the chassis 1, and is respectively connected to the foregoing dust detection apparatus 13 and air windows 111 (as shown in FIG. 5); in this way, when the dust detection apparatus 13 detects a dust distribution condition in the laser processing area 2 and reports the condition to the control apparatus 14, the control apparatus 14 can control air windows 111 at suitable locations to be opened or closed, so that dust inside the chassis 1 can be extracted out of the chassis 1 by the air extraction device 4 more effectively.

The foregoing is a specific embodiment of the present invention and technical means used in the specific embodiment. A lot of variations and modifications may be derived according to the disclosure or teaching of the present invention, and can be still considered as equivalent changes made according to the idea of the present invention, and functions generated thereby still do not go beyond the substantial spirit covered by the description and accompanying drawings, and should be considered to fall into the technical scope of the present invention.

Based on the above, according to the content disclosed in the foregoing text, the present invention can really achieve the expected objective of the invention, that is, to provide a box-type laser processing machine capable of vacuum dedusting, which is of great applicability and industrial use value.

### REFERENCE SIGNS

| | |
|---|---|
| 1: Chassis | 11: Air inlet hole |
| 111: Air window | 12: Air exhaust hole |
| 13: Dust detection apparatus | 14: Control apparatus |
| 2: Laser processing area | 3: Laser output apparatus |
| 4: Air extraction device | |

What is claimed is:

1. A box-type laser processing machine capable of vacuum dedusting, comprising a chassis; a laser processing area is provided inside the chassis for processing work of a laser output apparatus, and the box-type laser processing machine capable of vacuum dedusting is characterized in that: a plurality of air inlet holes is provided above the laser processing area in the periphery of the chassis, and an air exhaust hole is provided opposite to the laser processing area on the chassis; in this way, when air extraction is performed in the laser processing area inside the chassis by using an air extraction device, air outside the chassis is guided into the chassis via the plurality of air inlet holes to extract dust generated by processing work out of the chassis via the air exhaust hole.

2. The box-type laser processing machine capable of vacuum dedusting according to claim 1, wherein each of the plurality of air inlet holes has an air window that is able to be closed or opened, and at least one dust detection apparatus is further provided inside the chassis; a control apparatus is provided in the chassis, and is respectively connected to the dust detection apparatus and the air windows; in this way, when the dust detection apparatus detects a dust distribution condition in the laser processing area and reports the condition to the control apparatus, the control apparatus is able to control the air windows at suitable locations to be opened or closed.
